(19) United States
(12) Patent Application Publication
(10) Pub. No.: US 2013/0326634 A1
(43) Pub. Date: Dec. 5, 2013

(54) Simple Product Purchase for Multisystem Accounts

(71) Applicants: Clint H. O'Connor, Austin, TX (US); Michael Haze, Round Rock, TX (US)

(72) Inventors: Clint H. O'Connor, Austin, TX (US); Michael Haze, Round Rock, TX (US)

(21) Appl. No.: 13/483,202

(22) Filed: May 30, 2012

(51) Int. Cl. G06F 21/24

(52) U.S. Cl. 726/27

(57) ABSTRACT

A system and method are disclosed for managing the assignment of digital goods licenses. A user selects digital goods to be assigned to a group of target systems, followed by the retrieval of digital goods entitlement records for each system in the group. Systems that are not entitled to the selected digital goods are removed, along with any systems that already have the digital goods installed. If an insufficient number of licenses are available for the remaining systems in the group, then the number of required licenses is determined, followed by their procurement. The available and procured digital goods licenses are then respectively assigned to each system in the group.

### BACKGROUND OF THE INVENTION

1. Field of the Invention

Embodiments of the invention relate generally to information handling systems. More specifically, embodiments of the invention provide a system, method, an computer-readable medium for managing the assignment of digital goods licenses.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Current purchasing of digital goods often involves going online, accessing a vendor's site, scrolling through multiple lists or pages, and selecting a digital good. Once selected, boxes are typically checked for desired options, followed by clicking buttons to assign the selected item to a target system and then stepping through a payment process. This process is usually simple when a user is purchasing a single digital good for a single system. However, it quickly becomes cumbersome if a user is purchasing multiple digital goods for multiple systems, as the process has to be iteratively repeated for each digital good and for each system. This process can become even more cumbersome if the user also needs to determine whether uninstalled licenses to the desired digital goods have already been purchased, and if so, are they available for assignment to one or more systems.

These issues are typically addressed in corporate environments by information technology (IT) administrators, who use various known approaches to managing digital goods licenses. However, these approaches are typically disjoint, with the selection, purchase, and license assignment of the digital goods often handled as separate processes, and in some cases, separate organization. For example, one IT administrator may determine how many digital goods licenses they need and then generate a purchase request. A second IT administrator may then decide whether to purchase a la carte or in bundles (e.g., 5-, 10-, 100-, 250-, 500-count). Once the purchase is completed, a third IT administrator may be responsible for managing those licenses. Thereafter, yet another IT administrator may he responsible for installing the digital goods and associating their licenses to the right systems or users, all dependent upon the licensing terms. In larger operating environments, this process can quickly become complex and require sophisticated systems management software.

However, small to medium enterprises typically do not have a dedicated IT staff, nor can they justify systems and processes dedicated to managing licenses to digital goods and their assignment to various systems. Furthermore, it is becoming increasingly common for home offices to have a local area network (LAN) connecting multiple systems, each of which may have been assigned various digital goods licenses which can be transferred to new systems as old ones are replaced. These issues are further complicated when the user is unaware that they may own digital goods licenses that have not yet been assigned, which can result in unnecessary purchases.

### SUMMARY OF THE INVENTION

A system and method are disclosed for managing the assignment of digital goods licenses. In various embodiments, a digital goods entitlement system is implemented for the assignment of digital goods licenses to one or more target systems. In these and other embodiments, digital goods that are available are presented to a user. The user then selects digital goods to be assigned to a group of target systems, followed by the retrieval digital goods entitlement records for each system in the group.

The retrieved entitlement records are then processed to remove systems that are already entitled to the selected digital goods. The remaining systems in the group are then surveyed to identify those systems that already have the selected digital goods installed, which are in turn removed from the group. Then, digital goods policy records associated with each remaining system in the group are accessed, followed by removing systems that do not have policy rights to the selected digital goods.

Current terms for licensing the digital goods are then retrieved, along with other assigned and available licenses, for the remaining systems in the group. If an insufficient number of licenses are available for the remaining systems in the group, then the number of required licenses, along with their corresponding licensing options, terms, costs and discounts are determined. The user then approves the digital goods assignments and digital goods entitlements are created, associated with the systems in the group, and stored in each system's corresponding entitlement record. Thereafter, any needed digital goods licenses are procured, which are then respectively assigned along with the available licenses to each system in the group.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of the components of an information handling system as implemented in the system and method of the present invention;

FIG. 2 is a simplified block diagram of the operation of a digital goods entitlement system;

FIGS. 3a-b are a generalized flow chart of the performance of digital goods entitlement operations;

FIGS. 4a-b are a generalized flow chart of the performance of digital goods license assignment operations;

FIG. 5 is a generalized depiction of the performance of digital goods entitlement operations as implemented within a window of a user interface (UI); and

FIG. 6 is a generalized depiction of the performance of digital goods license assignment operations as implemented within a window of a UI.

### DETAILED DESCRIPTION

A system and method is disclosed for managing the assignment of digital goods licenses. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

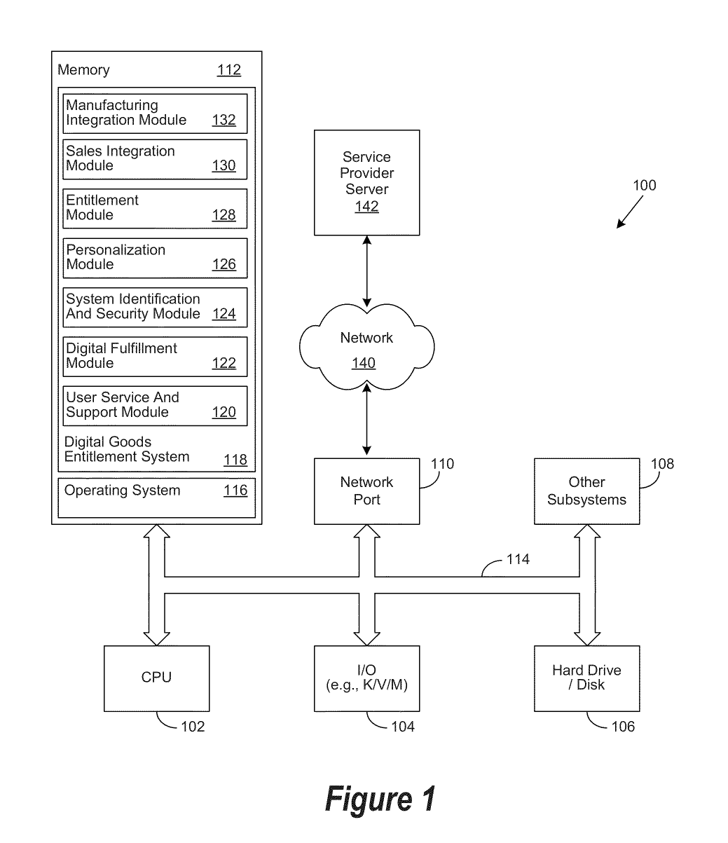

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112., which is interconnected to the foregoing via one or more buses 114. System memory 112 further comprises operating system (OS) 116 and in various embodiments may also comprise a digital goods entitlement system 118. In these and other embodiments, the digital goods entitlement system 118 may likewise comprise a user service and support module 120, a digital fulfillment module 122, a system identification and security module 124, a personalization module, an entitlement module 128, a sales integration module, and a manufacturing integration module 132. In one embodiment, the information handling system 100 is able to download the digital goods entitlement system 118 from the service provider server 142. In another embodiment, the digital goods entitlement system 118 is provided as a service from the service provider server 142.

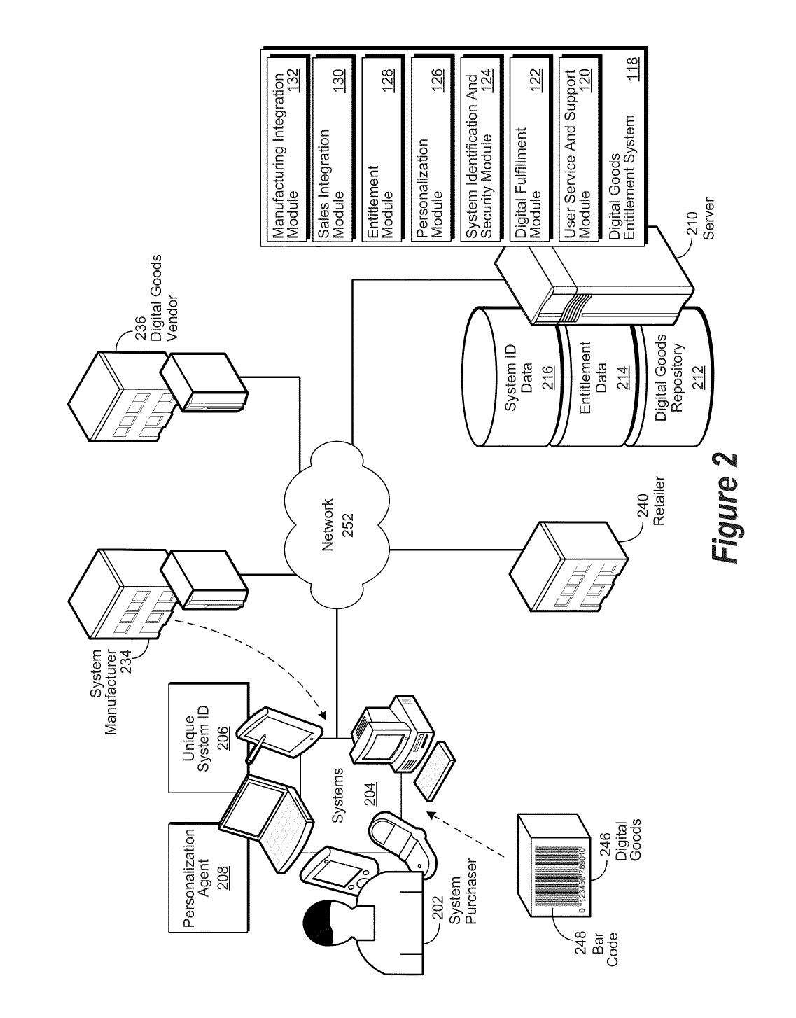

FIG. 2 is a simplified block diagram of the operation of a digital goods entitlement system as implemented in accordance with an embodiment of the invention. In various embodiments, a digital goods entitlement system 118 is implemented for managing the entitlement of a system 204 to process digital goods 246. In these and other embodiments, the digital goods entitlement system 118 may be implemented on one or more servers 210, which are connected to a network 252. As shown in FIG. 2, the digital goods entitlement system 118 comprises a user service and support module 120, a digital fulfillment module 122, and a system identification and security module 124. The digital goods entitlement system 118 likewise comprises a personalization module 126, an entitlement module 128, a sales integration module 130, and a manufacturing integration module 132. Likewise, the digital goods entitlement system 118 is able to access a digital goods data repository 212, an entitlement data repository 214, and a system identifier (ID) data repository 216, each of which may be implemented on one or more servers 210 connected to a network 252.

As used herein, a digital good 246 refers to any digital asset such as a software application, a deliverable or performable service, music, video, software activation key, personalization instructions, files, etc. that are digitally deliverable. As likewise used herein, a digital goods entitlement refers to the association of a predetermined digital good 248 with a target system 204. In various embodiments, an entitlement record contains the digital goods entitlement data (e.g., license information, etc.) that allows the digital good 248 to be processed by a target system 204 identified by a corresponding unique system identifier 206. In these and other embodiments, the entitlement record is processed by the entitlement module 128 and stored in the entitlement data repository 214. Likewise, as used herein, a system 204 may comprise a personal computer, a laptop computer, or a tablet computer operable to establish an on-line session with the digital goods entitlement system 118 over a connection to network 252. The system 204 may also comprise a personal digital assistant (PDA), a mobile telephone, or any other suitable device operable to store a unique system ID 206, perform digital goods entitlement operations described in greater detail herein, and establish a connection with network 252.

In this embodiment, digital goods entitlement and system personalization operations are performed by a user, such as a system purchaser 202, in either a physical environment or an on-line environment. As an example, a physical environment may comprise a retailer 240 operating a physical point-of-sale (POS) system 242. As another example, an on-line environment may comprise a system manufacturer 234, or digital goods vendor 236, that respectively accepts on-line orders for systems or digital goods over a connection to network 252.

If the digital goods entitlement and system personalization operations are performed in an on-line environment, then the system purchaser 202 decides whether to purchase a custom-configured or pre-configured system 204. If the system 204 is to be pre-configured, then it is selected for on-line purchase by the system purchaser 202 and its unique system identifier 206 is determined. In one embodiment, the unique system identifier 206 is stored in the BIOS of the pre-configured system 204. However, if the system 204 is to be custom-configured, then it is custom-configured for on-line purchase by the system purchaser 202. Once manufactured by the system manufacturer 234, a unique system identifier 206 is generated by the system manufacturer 234.

In various embodiments, the manufacturing integration module 132 coordinates the custom configuration of the system 204 with the digital goods entitlement system 118. Likewise, the system identification and security module 124 coordinates the generation of the unique system identifier 204 and its storage in the repository of system identifier data 216. The system purchaser then selects digital goods 246 for on-line purchase, followed by selecting personalization options for the pre-configured or custom-configured system. In various embodiments, the personalization module 126 coordinates the selection of personalization options with the digital goods entitlement system 118. As used herein, a system personalization option refers to any feature, capability, or function that may be applied to a target system. As an example, a personal computer desktop wallpaper or user interface options (e.g., a “classic” interface) are personalization options.

However, if the digital goods entitlement and system personalization operations are performed in a physical environment, then the system purchaser 202 selects a pre-configured system 204 and physical representations of digital goods 246 to be purchased. In various embodiments, the digital goods 2.46 are physically represented as images and text on a card or a package, yet the digital goods themselves are not contained within the card or package. The system purchaser 202 then selects system personalization options for the pre-configured system. In various embodiments, the system personalization options are likewise physically represented as images and text on a card or a package.

A purchase transaction for the custom-configured or pre-configured system 204 and any associated digital goods 246 and personalization options is then completed. In various embodiments, the processing of the purchase transaction is performed by the sales integration module 130. In these and other embodiments, the financial proceeds of the purchase transaction may be settled between multiple parties. For example, a system manufacturer 234 may receive a portion of the purchase transaction corresponding to the cost of the system 204. One or more digital goods vendors 236 may likewise receive a proportionate share of the purchase transaction corresponding to the digital goods 246 they respectively provide.

Digital goods entitlement operations, as described in greater detail herein, are then performed by the digital goods entitlement system 118 to bind the digital goods 246, the personalization options, and their respective digital goods entitlement data to the unique system identifier 206 of the target system 204. The resulting bound data, including data associated with the digital goods (e.g., installation files, etc.) is then stored in the repository of entitlement data 214 and the purchased system 204 is then delivered to the system purchaser 202. In various embodiments, the entitlement module 128 generates, and then processes, the digital goods entitlement data and the user service and support module 120 coordinates the delivery of the system 204 to the system purchaser 202.

Standard operating system (OS) out-of-the-box-experience (OOBE) or hypervisor boot operations are performed on the system 204, followed by loading a personalization agent 208. In various embodiments, the personalization agent 208 has a unique identifier that is associated with one or more unique system component identifiers. In one embodiment, the unique identifier of the personalization agent is uniquely associated with the current unique system identifier 206 associated with the system 204. In another embodiment, a portion of the personalization agent 208 is delivered to the system 204 in an encrypted form and is then decrypted prior to being loaded on the system 204. In this embodiment, the primary system identifier (e.g., service tag number, serial number, etc.), is used as a decryption key to decrypt the personalization agent 208.

In various other embodiments, secondary system identifiers are stored on the system 204 (e.g., in the BIOS, in Flash memory, on a hard disk, etc.) as well as in the digital goods entitlement system 118. In these and other embodiments, the digital goods entitlement system 118 uses the secondary system identifiers to encrypt a portion of the personalization agent 208 before it is downloaded to the system 204. Once downloaded, the unencrypted portion of the personalization agent 208 uses the secondary system identifiers stored on the system 204 to decrypt the encrypted portion of the personalization agent 208. In one embodiment, the secondary system identifiers are likewise encrypted and are first decrypted before they are used to decrypt the encrypted portion of the personalization agent 208. In another embodiment, the secondary system identifiers are stored in a Trusted Platform Module (TPM). Skilled practitioners of the art will recognize that many such embodiments are possible and the foregoing is not intended to limit the spirit, scope, or intent of the invention.

The personalization agent 208 queries the target system for its unique system identifier 206. In various embodiments, the unique system identifier 206 associated with the system 204 is stored in the target system's BIOS, flash memory, a hard disk, or other memory device. The personalization agent 208 then automatically establishes a connection with the digital goods entitlement system 118 and uses the unique system identifier 206 to authenticate the system 204. The unique system identifier 206 is then used by the personalization agent 208 to determine entitled digital goods and personalization options corresponding to the unique system identifier 206.

Once determined, the corresponding personalization options and digital goods 246, along with their associated digital goods entitlement data, are respectively downloaded to the target system 204 from the repository of digital goods 212 and the repository of entitlement data 214. In one embodiment, the personalization options and digital goods, along with their associated digital goods entitlement data, are downloaded from a single server 210 on the network 252. In another embodiment, the personalization options and digital goods are downloaded from one or more servers 210 on the network 252. In yet another embodiment, the personalization options, digital goods, and associated digital goods entitlement data are respectively downloaded from a plurality of servers 210 on a network 252. In these and other embodiments, the digital goods entitlement system 118 manages the respective location of the personalization options, digital goods, and associated digital goods entitlement data to initiate its provision. Once downloaded, the personalization agent 208 uses the digital goods entitlement data to install the digital goods 246 and personalization options on the system 204.

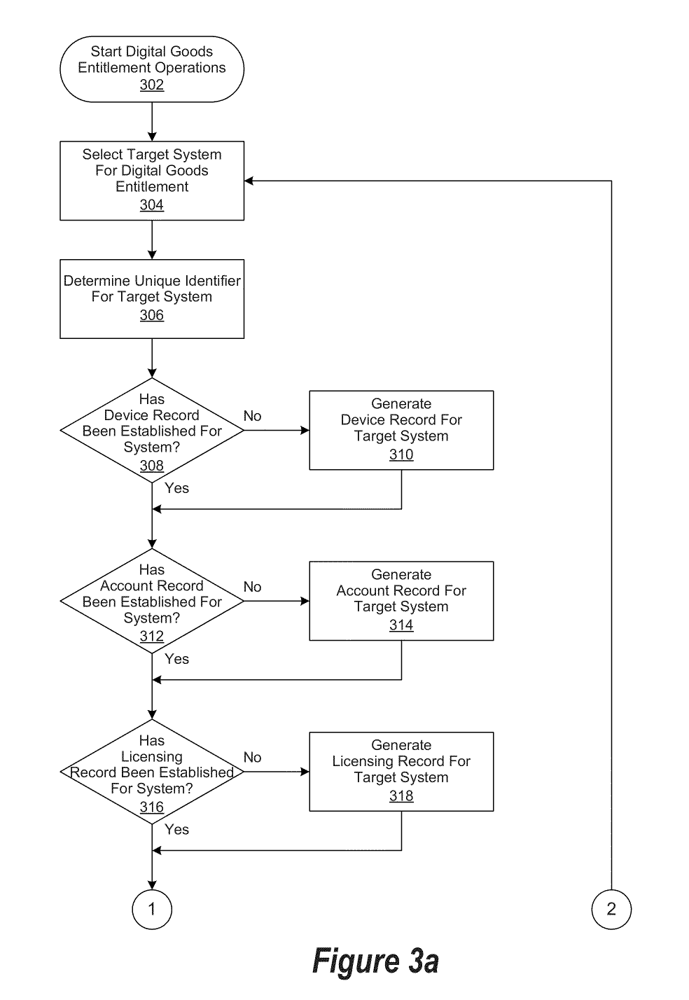

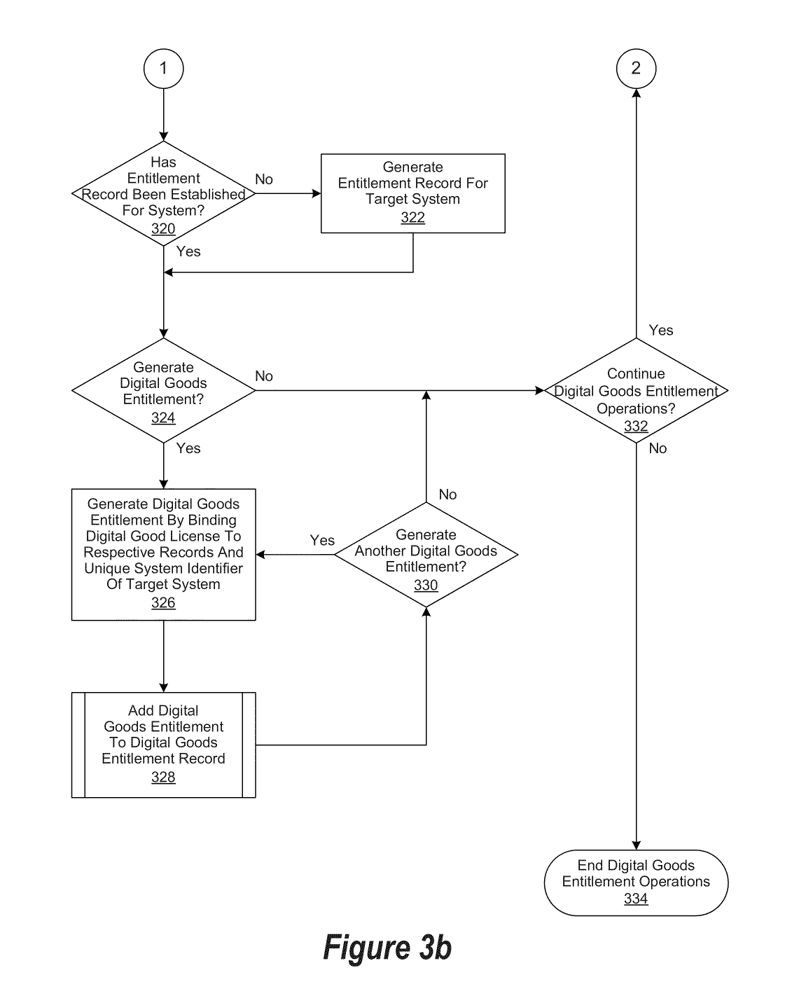

FIGS. 3a-b are a generalized flow chart of the performance of digital goods entitlement operations in an embodiment of the invention. In this embodiment, digital goods entitlement operations are started in step 302, followed by the selection of a target system in step 304 for digital goods entitlement. The unique system identifier of the target system, as described in greater detail herein, is determined in step 306, followed by a determination being made in step 308 whether a device record has been established for the target system. If not, then the device record is generated in step 310. As used herein, a device record refers to a data record containing data related to a system which will receive an entitlement to process associated digital goods. In various embodiments, the unique system identifier of the target system is stored in the device record. In various embodiments, other records may be associated with the device record to further describe the system, such as its model, type, make, internal identifiers, etc.

Once the device record has been generated, or if it is determined in step 308 that it has already been established, then a determination is made in step 312 whether an account record has been established. If not, then the account record is generated in step 314. As used herein, an account record refers to a data record containing data related to the association of multiple devices or systems to one or more entities. In various embodiments, the entity may be a single individual or a group of individuals. As an example, the entity may be a household with multiple PCs, a small business with several employees, a large corporation with many employees, etc. Other records may be attached to the account to further describe the account holder, payment information related to the account, etc. Accounts may further be broken down or organized into sub-accounts as needed, such as to describe departments within an enterprise). In various embodiments, a user may be associated with a single device or system or multiple devices or systems in the account record. Conversely, a group of users may be associated with a single device or system or multiple devices in the account record. Furthermore, groups of individual users may likewise be associated with groups of individual devices or systems. Those of skill in the art will recognize that many such associations are possible and the foregoing is not intended to limit the spirit, scope, or intent of the invention.

Once the account record has been generated, or if it is determined in step 312 that it has already been established, then a determination is made in step 316 whether a licensing record has been established. If not, then a licensing record is generated in step 318. As used herein, a licensing record refers to a data record containing data related to the licensing (e.g., original equipment manufacturer, or OEM license, retail license, educational license, site license, etc.) of a digital good to be processed on a target system. In various embodiments other records may be associated with the licensing record to further describe the type of license, number of licenses, use and reuse restrictions, expiration, other policy information, and other information related to the license.

Once the licensing record has been generated, or if it is determined in step 316 that it has already been established, then a determination is made in step 320 whether an entitlement record has been established. If not, then an entitlement record is generated in step 322. As used herein, an entitlement record refers to a data record containing data related to the association of a predetermined digital good with a target system. In various embodiments, the entitlement record contains the data (e.g., license information, etc.) that allows the digital good to be processed by a target system identified by a corresponding unique system identifier. In various embodiments, the entitlement record is associated with the device record, the account record, and licensing record respectively generated in steps 310, 314, and 316. In these and other embodiments, other records may be attached to the entitlement record to further describe the type and attributes of the entitlement, binding type (e.g., whether it is bound to a device or an account), and details and attributes related to the digital good.

Once the entitlement record has been generated, or if it is determined in step 320 that it has already been established, then a determination is made in step 324 whether to generate a digital goods entitlement. If not, then a determination is made in step 332 whether to continue digital goods entitlement operations. If so, then the process is continued, proceeding with step 304. Otherwise digital goods entitlement operations are ended in step 334. However, if it is determined in step 324 to generate a digital goods entitlement, then it is generated by selecting a target digital good in step 326 and then performing operations to associate its corresponding license record with the aforementioned device record, account record, and other predetermined records. The resulting digital goods entitlement association is then added to the entitlement record in step 328. A determination is then made in step 330 whether to generate another digital goods entitlement. If so, the process is continued, proceeding with step 326. Otherwise, a determination is made in step 332 whether to continue digital goods entitlement operations. If so, then the process is continued, proceeding with step 304. Otherwise digital goods entitlement operations are ended in step 334.

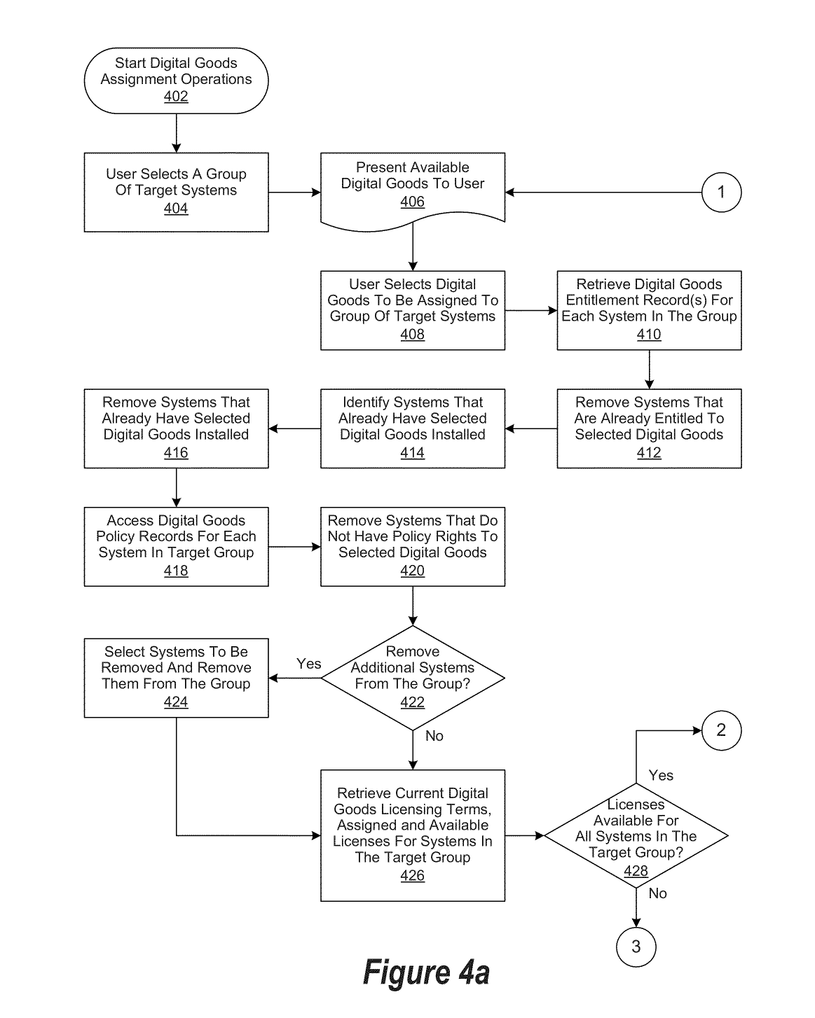

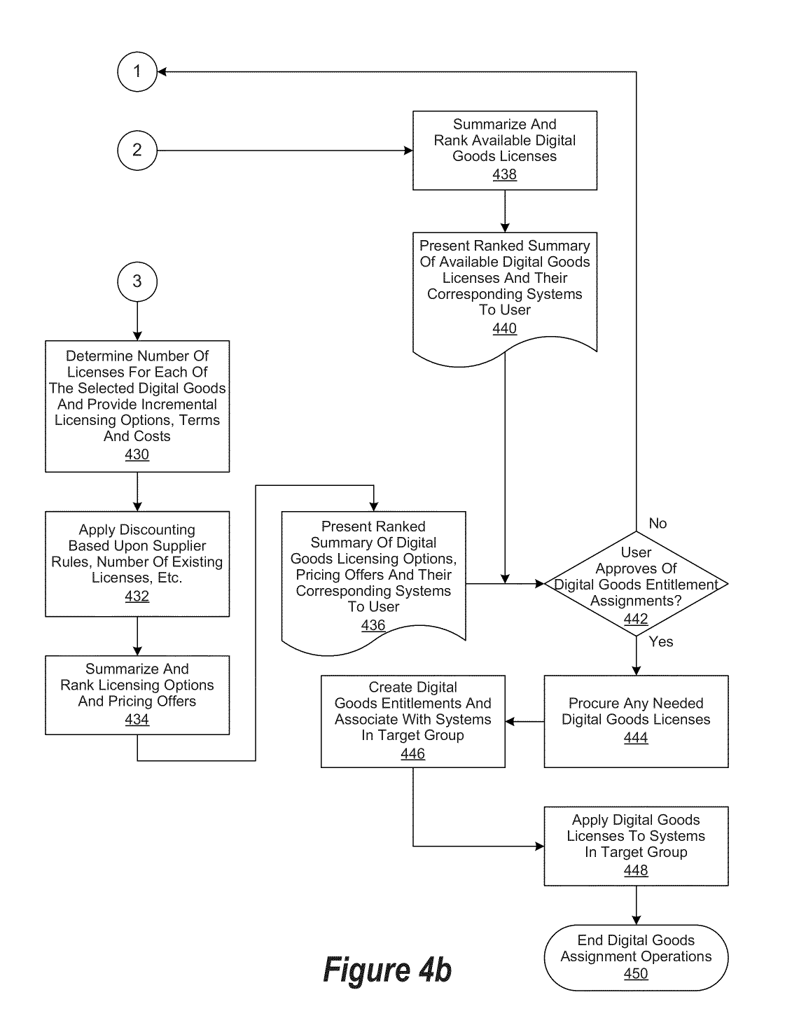

FIGS. 4a-b are a generalized flow chart of the performance of digital goods license assignment operations in an embodiment of the invention. In this embodiment, digital goods entitlement operations are started in step 402, followed by the selection of a target group of systems by a user in step 404. Digital goods that are available for assignment are then presented to the user in step 406. The user then selects digital goods to be assigned to a group of target systems in step 408, followed by the retrieval in step 410 of one or more digital goods entitlement records for each system in the group. The retrieved entitlement records are then processed in step 412 to remove systems that are already entitled to the selected digital goods. The remaining systems in the group are then surveyed in step 414 to identify those systems that already have the selected digital goods installed. As an example, the digital goods may have been previously purchased and installed. In one embodiment, entitlement records associated with the identified systems are respectively updated to reflect that the selected digital goods are installed on each identified system. Systems that already have the selected digital goods installed are then removed from the group in step 416. Then, in step 418, digital goods policy records associated with each remaining system in the group are accessed, followed by removing systems that do not have policy rights to the selected digital goods in step 420. As an example, a digital goods policy record may state that systems assigned to a company's shipping department are not authorized for the installation of a photo editing application.

A determination is then made in step 422 whether to remove additional systems from the group. If so, then predetermined systems are selected and removed from the group in step 424. If not, or once predetermined systems are selected and removed in step 424, then current terms for licensing the digital goods are retrieved in step 426 along with other assigned and available licenses, for the remaining systems in the group. A determination is then made in step 428 whether sufficient licenses for the selected digital goods are available for all remaining systems in the group. If not, then the number of licenses required for the remaining systems is determined in step 430, along with corresponding incremental licensing options, terms and costs. Discounts are then applied to the incremental licensing options, terms and costs in step 432, according to predetermined digital goods supplier rules, number of existing licenses, etc. Ranked licensing options and pricing options are then summarized in step 434, followed by presenting the ranked summary, and a list of corresponding systems in step 436.

However, if it is determined in step 428 that sufficient licenses for the selected digital goods are not available for all remaining systems in the group, then available digital goods licenses are ranked and summarized in step 438, followed by presenting the ranked summary, and a list of corresponding systems in step 440. A determination is then made in step 442 whether the user approves of the digital goods assignment in step 442. If not, then the process is continued, proceeding with step 406. Otherwise, the user approves the digital goods assignments in step 444 and any needed licenses for the assigned digital goods are procured as described in greater detail herein. Then, in step 446, entitlements are created, associated with the systems in the group, and stored in each system's corresponding entitlement record. Thereafter, in step 448, the digital goods licenses corresponding to the digital goods entitlements are respectively applied to each system in the group. Digital goods license assignment operations are then ended in step 450.

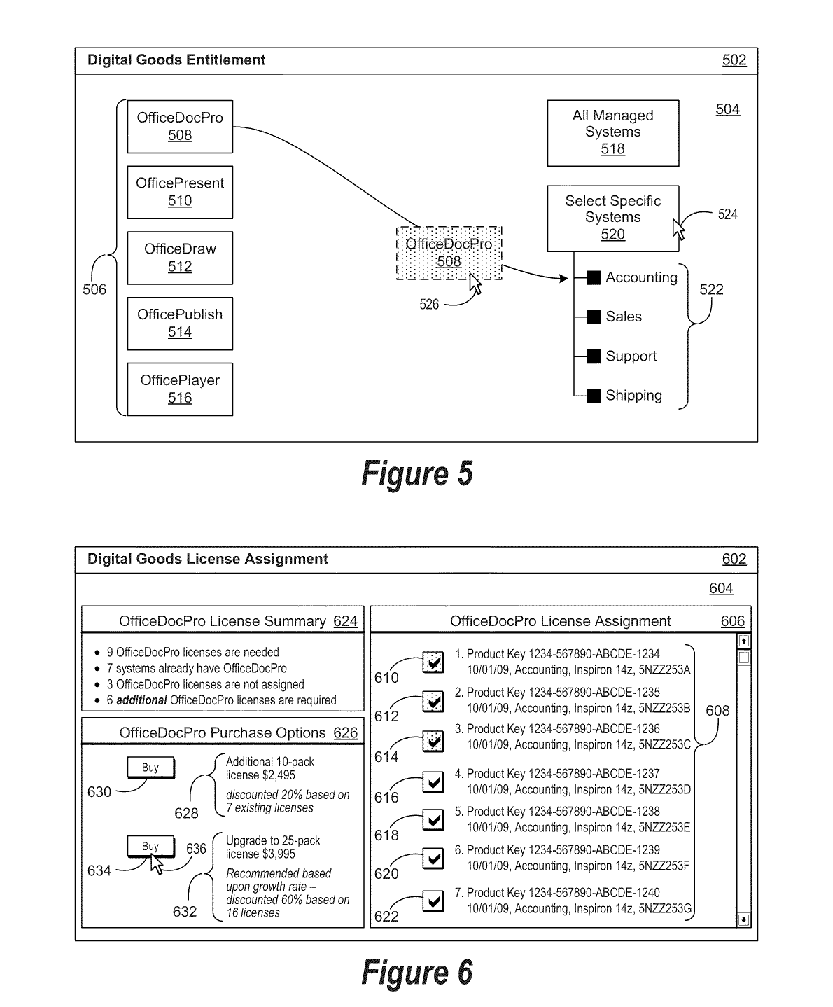

FIG. 5 is a generalized depiction of the performance of digital goods entitlement operations as implemented in accordance with an embodiment of the invention within a window of a user interface (UI). In this embodiment, a digital goods entitlement system, as described in greater detail herein, is implemented within a UI window 504 of a UI 502, such as the UI of a web browser, for entitling one or more target systems to the use of predetermined digital goods. As shown in FIG. 5, the UI window 504 comprises a plurality of digital goods icons 506, an “All Managed Systems” icon 518 representing all systems managed by the user, and a “Select Specific Systems” icon 520 representing various groupings 522 of systems managed by the user. As likewise shown in FIG. 5, the plurality of digital goods icons 506 comprises an ‘OfficeDocPro’ icon 508, an ‘OfficePresent’ icon 510, an ‘OfficeDraw’ icon 512, an ‘OfficePublish’ icon 514, and an ‘OfficePlayer’ icon 516.

In this embodiment, a user has elected not to assign the digital goods represented by the ‘OfficeDocPro’ icon 508 to the systems represented by the “All Managed Systems.” Instead, the user has elected to assign the digital goods represented by the ‘OfficeDocPro’ icon 508 to various system groupings represented by the “Select Specific Systems” icon 520. To do so, the user employs a user gesture, such as a mouse click with cursor 524 on the “Select Specific Systems” icon 520, which reveals the various groupings 522 of systems managed by the user. In turn, the user employs another user gesture, such as a click, hold and drag with cursor 526 to drag the ‘OfficeDocPro’ icon 508 to the ‘Accounting’ grouping of the various groupings 522 of systems managed by the user. The ‘OfficeDocPro’ icon 508 is then ‘dropped’ onto the ‘Accounting’ grouping, which then initiates the assignment of the digital goods represented by the ‘OfficeDocPro’ icon 508 to the systems associated with the ‘Accounting’ grouping of systems managed by the user.

FIG. 6 is a generalized depiction of the performance of digital goods license assignment operations as implemented in accordance with an embodiment of the invention within a window of a user interface (UI). In this embodiment, a digital goods entitlement system, as described in greater detail herein, is implemented within a UI window 604 of a UI 602, such as the UI of a web browser, for the assignment of digital goods licenses to one or more target systems. As shown in FIG. 6, the UI window 604 comprises an “OfficeDocPro License Assignment” sub-window 606, an “OfficeDocPro License Summary” sub-window 624, and an “OfficeDocPro Purchase Options” sub-window 626. In this embodiment, the user has completed the digital goods assignment operations described in the descriptive text of FIG. 5. As a result, the ‘Accounting’ grouping of the various groupings 522 managed by the user have become entitled to the use of the digital goods represented by the ‘OfficeDocPro’ icon 508 shown in FIG. 5.

As shown in FIG. 6, the “OfficeDocPro License Assignment” sub-window 606 comprises a list of systems 608 associated with the ‘Accounting’ grouping, each of which has a corresponding checkbox 610, 612, 614, 616, 618, 620, and 622, signifying that each of the systems 608 associated with the ‘Accounting’ grouping has been assigned a license associated with the digital goods represented by the ‘OfficeDocPro’ icon 508 shown in FIG. 5. As shown in the “OfficeDocPro License Assignment” sub-window 606, checkboxes 610, 612 and 614 are shaded, signifying that licenses associated with the digital goods represented by the ‘OfficeDocPro’ icon 508 shown in FIG. 5 are available and are now assigned to their corresponding systems. However, as likewise shown in the “OfficeDocPro License Assignment” sub-window 606, checkboxes 616, 618, 620, and 622 are not shaded, signifying that licenses associated with the digital goods represented by the ‘OfficeDocPro’ icon 508 shown in FIG. 5 are not available for assignment and need to be purchased.

As likewise shown in FIG. 6, a summary of the licenses associated with digital goods represented by the ‘OfficeDocPro’ icon 508 is displayed within the “OfficeDocPro License Summary” sub-window 624, which shows that an additional six (6) licenses are needed. In this embodiment, license purchase options are displayed within the “OfficeDocPro Purchase Options” sub-window 626. As shown in FIG. 6, the user is provided a first 628 purchase option to purchase an additional ten licenses and a second 632 purchase option to purchase an additional twenty five licenses. As likewise shown in FIG. 6, the first 628 and second 632 purchase options have a corresponding first 630 and second 632 ‘Buy’ command button, which can be selected through the use of a user gesture, such as a mouse-click with cursor 636. As described in greater detail herein, selection of the first 630 or second 632 ‘Buy’ command button initiates the purchase, and subsequent assignment, of licenses associated with the digital goods represented by the ‘OfficeDocPro’ icon 508 shown in FIG. 5. It will be appreciated that many such embodiments are possible and the foregoing is not intended to limit the spirit, scope or intent of the invention.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for managing rights to digital goods, comprising:
providing digital goods data associated with a set of digital goods;
providing system data associated with a plurality of handling systems;
receiving digital goods selection data and information handling system selection data, the digital goods selection data corresponding to a subset of the set of digital goods and the information handling system selection data corresponding to a subset of the plurality of handling systems;
processing the digital goods selection data and the information handling system selection data to generate digital goods entitlement data; and
processing the digital goods entitlement data to entitle the subset of information handling systems to use the subset of digital goods.

2. The method of claim 1, wherein:
the digital goods data comprises license data corresponding to the subset of digital goods, the license data comprising a set of licenses to use the subset of digital goods;
the digital goods entitlement data and the license data are processed to generate license assignment data; and
the license assignment data is processed to assign the set of licenses to the subset of information handling systems.

3. The method of claim 2, wherein:
the license data is further processed to generate a set of license quantity data comprising the number of licenses contained in the set of licenses;
the information handling system selection data is further processed to generate a set of system quantity data comprising the number of information handling systems contained in the subset of information handling systems; and
the number of licenses contained in the set of licenses contains is fewer than the number of information handling systems contained in the subset of information handling systems.

4. The method of claim 3, wherein:
the set of license quantity data and the set of system quantity data are processed to generate license procurement data; and
the license procurement data is processed to generate the number of licenses to be procured.

5. The method of claim 4, wherein the license procurement data comprises at least one of the set of:
license policy terms;
license promotion terms;
license pricing terms; and
license pricing discount terms.

6. The method of claim 5, wherein the license procurement data is processed to initiate the procurement of the number of licenses to be procured.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing digital goods data associated with a set of digital goods;
providing system data associated with a plurality of handling systems;
receiving digital goods selection data and information handling system selection data, the digital goods selection data corresponding to a subset of the set of digital goods and the information handling system selection data corresponding to a subset of the plurality of handling systems;
processing the digital goods selection data and the information handling system selection data to generate digital goods entitlement data; and
processing the digital goods entitlement data to entitle the subset of information handling systems to use the subset of digital goods.

8. The system of claim 1, wherein:
the digital goods data comprises license data corresponding to the subset of digital goods, the license data comprising a set of licenses to use the subset of digital goods;
the digital goods entitlement data and the license data are processed to generate license assignment data; and
the license assignment data is processed to assign the set of licenses to the subset of information handling systems.

9. The system of claim 8, wherein:
the license data is further processed to generate a set of license quantity data comprising the number of licenses contained in the set of licenses;
the information handling system selection data is further processed to generate a set of system quantity data comprising the number of information handling systems contained in the subset of information handling systems; and
the number of licenses contained in the set of licenses contains is fewer than the number of information handling systems contained in the subset of information handling systems.

10. The system of claim 9, wherein:
the set of license quantity data and the set of system quantity data are processed to generate license procurement data; and
the license procurement data is processed to generate the number of licenses to be procured.

11. The system of claim 10, wherein the license procurement data comprises at least one of the set of:
license policy terms;
license promotion terms;
license pricing terms; and
license pricing discount terms.

12. The system of claim 11, wherein the license procurement data is processed to initiate the procurement of the number of licenses to be procured.

13. A non-transitory, computer-readable storage medium embodying computer program code, the computer program code comprising computer executable instructions configured for:
providing digital goods data associated with a set of digital goods;
providing system data associated with a plurality of handling systems;
receiving digital goods selection data and information handling system selection data, the digital goods selection data corresponding to a subset of the set of digital goods and the information handling system selection data corresponding to a subset of the plurality of handling systems;
processing the digital goods selection data and the information handling system selection data to generate digital goods entitlement data; and
processing the digital goods entitlement data to entitle the subset of information handling systems to use the subset of digital goods.

14. The non-transitory, computer-readable storage medium of claim 13, wherein:
the digital goods data comprises license data corresponding to the subset of digital goods, the license data comprising a set of licenses to use the subset of digital goods;
the digital goods entitlement data and the license data are processed to generate license assignment data; and
the license assignment data is processed to assign the set of licenses to the subset of information handling systems.

15. The non-transitory, computer-readable storage medium of claim 14, wherein:
the license data is further processed to generate a set of license quantity data comprising the number of licenses contained in the set of licenses;
the information handling system selection data is further processed to generate a set of system quantity data comprising the number of information handling systems contained in the subset of information handling systems; and
the number of licenses contained in the set of licenses contains is fewer than the number of information handling systems contained in the subset of information handling systems.

16. The non-transitory, computer-readable storage medium of claim 15, wherein:
the set of license quantity data and the set of system quantity data are processed to generate license procurement data; and
the license procurement data is processed to generate the number of licenses to be procured.

17. The non-transitory, computer-readable storage medium of claim 16, wherein the license procurement data comprises at least one of the set of:
license policy terms;
license promotion terms;
license pricing terms; and
license pricing discount terms.

18. The non-transitory, computer-readable storage medium of claim 17, wherein the license procurement data is processed to initiate the procurement of the number of licenses to be procured.

19. The non-transitory, computer readable storage medium of claim 13, wherein the computer executable instructions are deployable to a client computer from a server at a remote location.

20. The non-transitory, computer readable storage medium of claim 13, wherein the computer executable instructions are provided by a service provider to a customer on an on-demand basis.
